(19) United States
(12) Patent Application Publication
(10) Pub. No.: US 2024/0167907 A1
(43) Pub. Date: May 23, 2024

(54) APPARATUS, SYSTEMS, AND METHODS FOR LEAK DETECTION

(71) Applicant: Finley MILLER, Long Beach, CA (US)

(72) Inventor: Finley MILLER, Long Beach, CA (US)

(21) Appl. No.: 18/500,808

(22) Filed: Nov. 2, 2023

Related U.S. Application Data
(60) Provisional application No. 63/425,374, filed on Nov. 15, 2022.

(51) Int. Cl. G01M 3/26

(52) U.S. Cl. CPC G01M 3/26

(57) ABSTRACT

A pressure sensor comprises an oxygen sensitive luminophoric material encased in a permeable material adjacent to the same or similar type of oxygen sensitive luminophoric material encased in an impermeable material where the contrast between the electromagnetic waves emitted from each luminophoric material provides an indication of the local oxygen pressure. Alternatively, a device comprising a photosensor and an electromagnetic wave source may be used to excite and interrogate an oxygen-sensitive luminophoric material and to deduce the local oxygen pressure, based on the intensity of the luminescent output of the luminophoric material. The information may be used to efficiently locate leaks in vacuum-bag assisted manufacturing processes, in locating gas leak-paths in a solid surface, or other pressure-sensing applications.

### CROSS-REFERENCE TO RELATED APPLICATIONS

This application claims priority to and benefit of U.S. Provisional Patent Application No. 63/425,374, to Miller, entitled “Apparatus, Systems, and Methods to Determine Pressure Gradients and Locate Leak Sources in Pressure Sensitive Manufacturing Processes Using Oxygen-Sensitive Chemicals,” filed on Nov. 15, 2022, the contents of which are incorporated by reference in their entireties.

### FIELD OF THE DISCLOSURE

The present invention relates to pressure sensors utilizing oxygen-sensitive luminophoric materials and methods for detecting local oxygen pressure. More specifically, the disclosure pertains to devices and techniques for locating leaks in manufacturing processes, detecting gas leak-paths in solid surfaces, and other pressure-sensing applications.

### BACKGROUND OF THE INVENTION

Various chemicals that can be used to provide an optical indication of the presence of oxygen have been used in oxygen sensors, in pressure sensitive paint for wind-tunnel models, in food storage applications, in medical research, and in manufacturing. The techniques that have thus far been employed in using oxygen-sensitive chemicals in vacuum processing of composites and laminates to detect and located leaks, have never achieved widespread adoption due to cost, complexity, and difficulties in use. Air leaks continue to be a recurring issue for certain manufacturing methods used in the fabrication of composite structures. Accordingly, there is a need for methods to rapidly detect and locate leaks with equipment that is both affordable, rapid to use, and does not require unusual expertise from the operator.

There are several different classes of oxygen-sensitive chemicals that can be used to provide visual indications for the purpose of measuring vacuum levels or determining pressure gradients. The most versatile category of indicator materials are known as fluorescent dyes or luminophores. The techniques described here are novel techniques to employ already-known chemical processes and materials to specific applications related to certain manufacturing and inspection processes. Various materials can be used as a luminophoric oxygen sensor, including but not limited to H₂TSPP, H₂TCPP, H₂(Mo₂N)TFPP, PtTFPP, PtOEP, and Ru(ph₂-phen). These materials generally function by being excited by UV or visible light which causes them to emit photons as they return back to their stable ground state. When more oxygen is present, they may return to the ground state by processes that do not involve the emission of photons. The intensity and duration of that emission depends both upon the degree of stimulation and upon the concentration of oxygen in the area surrounding the sensor molecules. Other oxygen-sensitive visual indicators can also perform this function, such as UV activated non-fluorescent dyes that change color with oxygen exposure, but they have thus far proved to be inferior for a variety of reasons.

There are several known techniques for interrogating the various oxygen sensitive materials so that useful pressure information may be derived. The first of these is sometimes referred to as the “intensity method”. In this method, the area of interest has been covered with the oxygen sensitive material, it is then illuminated with an excitation light. A photo is then taken with a known, uniform pressure surrounding the inspection surface. This is sometimes called the “reference” image. Then the dynamic pressure condition is applied. For example, in the case of wind tunnel modelling, the wind is turned on, which creates an uneven pressure distribution over the inspection surface. A second photo (“run” image) is taken in this dynamic pressure condition. The two photos are processed by a software program to create an image showing a colorized pressure gradient over the inspection surface. Because the position of the camera, the light, and the inspection area light are held constant, the change in luminescent intensity of the film surface is known to be caused by the change in local oxygen pressure and the pressure distribution across the area of interest. Variations in the applied coating or in the intensity of the excitation light are cancelled out by comparing the reference and the run images, so that the pressure across the inspection area may be precisely identified.

A second technique for interrogating the oxygen sensitive luminophores to deduce local oxygen pressure is also commonly used in the wind tunnel environment, and referred to as the “Lifetime Method”. After being exposed to the excitation light, oxygen sensitive luminophores emit photons to return to the ground state, and also may return to the ground state by oxygen quenching, as previously noted. The intensity of emission varies based on the degree of excitation and also on the surrounding concentration of oxygen. After the excitation is removed, the decay of the luminescent emission from the oxygen sensitive luminophore also varies based on the availability of oxygen. In the “lifetime” method, there is no need to take a reference photo with the inspection area in a condition of uniform pressure, as there is with the intensity method. A “reference” image is taken with the excitation light on, in the dynamic pressure environment. A “run” image is taken at a predetermined interval after the light has been turned off. Typically the time intervals of each image are on the order of tens of microseconds, because of the brevity of the period where these materials luminesce after the excitation has been removed. Because the brief duration of the effect, in some cases a series of images are collected with the excitation source strobing on and off in sync with the camera images. A composite image is then created for the “run” image, and another composite image is created for the “reference” image. These two images are then typically processed using software, to create an final image showing a colorized pressure gradient across the inspection area. This method has a great advantage over the intensity method, because it can be impractical to take a uniform-pressure reference image. The Lifetime Method may also be more precise than the Intensity Method, because the inspection area may move when the dynamic pressure environment is engaged. For example in the case of a wind tunnel model, it may deflect when the wind is turned on. Because of this, the reference and run images may not be perfectly comparable.

A third technique for interrogating the oxygen sensitive luminophores to deduce local oxygen pressure, is known as the “dual sensor” method. In this technique, two luminophores dispersed in the same transparent binder. They are excited by the same excitation, but have a different response to oxygen and emit photons with differing wavelengths. For example one luminophore is highly sensitive to oxygen and emits light around 650 nm. The second luminophore is largely insensitive to oxygen and emits light around 550 nm. An imaging technique is used to interrogate the dual-luminophore material whereby the “run” image is obtained by collecting the red light and the “reference” image is taken by collecting the 550 nm light. Band-pass filters or digital techniques may be used to isolate the light emission around 550 nm to create the reference image, and also to isolate the light around 650 nm to create the run image. The relative intensity of the two images is compared using software to determine the pressure across the surface.

A fourth technique, which may be known as the “reversion method” is also used, though not with oxygen sensitive luminophores. In this case, UV sensitive dyes are placed in an inert environment. Typically it may be in a vacuum, or nitrogen environment. They are then exposed to UV which causes them to change in visible appearance, often bleaching from a dark color to a more light color. These dyes then revert back to their earlier appearance when exposed to oxygen. Some types may be reused multiple times, and other degrade significantly in one use. These are used frequently in food packaging. The main downside is their slow response time, limited reversibility, and the necessity to expose them to the UV in a vacuum/inert state, which is only practical in certain use cases.

Various manufacturing processes use flexible impermeable films, sometimes referred to as “vacuum bags” or vacuum bag film, to compress materials during a manufacturing process. These manufacturing processes include fabrication of fiber-reinforced polymer composite structures, bonding of two or more articles under pressure, fabrication of laminated structures such as transparent polycarbonate laminate windows, and applying a veneer or other surface treatment. The impermeable vacuum bag film can be made from nylon, silicone rubber, or other impermeable or semi-permeable flexible polymer membranes. The key attribute of the manufacturing process is that consistent pressure can be applied over a wide area with relatively inexpensive and versatile equipment by drawing a vacuum under the film and allowing the surrounding atmospheric pressure to compress the materials. It is important that excessive air (or other gasses) cannot leak through or around the membrane since this potentially has a negative effect on the manufacturing process and on process consistency. It is therefore important to verify that no significant vacuum leaks exist, and to locate and repair them if they are detected. A variety of techniques are often used to this end, but they generally are time consuming, they sometimes are inaccurate, and they may be sensitive to operator experience and capability.

One of the highest value manufacturing applications for vacuum bags is in the manufacture of composite structures for use in aviation. New aircraft types have substantially shifted from aluminum structures to carbon fiber/epoxy structures, which may be a lighter weight while achieving the same or greater strength and stiffness. The vast majority of these structures are manufactured using vacuum bags. A typical configuration for manufacturing a carbon-fiber/epoxy composite (hereafter “CFRP” for carbon fiber reinforced polymer) aircraft structure is described below. This configuration is an example of one of the various configurations that may benefit from these methods and devices. There is typically a rigid impermeable mold which the uncured CFRP materials are disposed onto, which is designed to define the desired geometry of the final part. After the mold has been prepared, the uncured CFRP materials are deposited by any of various methods. Then ancillary materials may be positioned over the CFRP which may be intended to improve surface texture, allow air evacuation, limit resin flow, or serve various other purposes. A vacuum bag is disposed over the various materials and sealed to the mold tool around the perimeter. The air between the vacuum bag and the tool is withdrawn through a port that connects to a vacuum pump. The assembly is typically checked for leaks to ensure that adequate vacuum levels are applied and that there are not undesirable air leaks into the assembly. By means of this assembly, the CFRP is uniformly compressed during the molding process, which removes undesirable voids within the material and provides for consistent thickness and mechanical properties in the resulting structure. After the vacuum has been applied and verified, the assembly is then typically processed in an oven or autoclave (a pressurized oven) at elevated temperature, which causes a chemical reaction whereby a liquid resin solidifies around the fibrous material to form a rigid structure. After cure, the ancillary materials, including the impermeable vacuum membrane are removed, and then the part is removed from the mold and inspected. The mold is cleaned and prepared for re-use. Countless variations on this basic process exist, and this description is only meant to illustrate one of many applications for impermeable polymeric vacuum films in manufacturing processes.

In 1969, one of the first references for sensing oxygen concentration using luminophores was disclosed in U.S. Pat. No. 3,612,866 to Stevens, entitled “Instrument for Determining Oxygen Quantities by Measuring Oxygen Quenching of Fluorescent Radiation.” The '866 patent discloses an apparatus for measuring oxygen concentration based on oxygen quenching of molecular luminescence. The quenching is evaluated by comparison with an oxygen-shielded reference member in the same environment, using respective photosensitive detectors responding to fluorescence from an unshielded fluorescing member and the reference member.

In 1980, Peterson and Fitzgerald (Peterson, J. I. and Fitzgerald, R. V., Rev. Sci. Instrum., 51, 670 (1980)) proposed oxygen quenching of fluorescent dyes for flow visualization in a wind tunnel. In their experiment, the luminescent dye was adsorbed onto silica particles. The coating was rough and adherence was a problem. No attempt at quantitation was made.

Oxygen-sensitive indicators can be incorporated into transparent membranes that extend over the surface of the entire article being manufactured, for the purpose of rapidly and precisely locating leaks that may otherwise impair the manufacturing process. This technique was proposed for fabricating composite structures (Miller and Benne U.S. Pat. No. 7,849,729B2, Miller and Benne U.S. Pat. No. 8,505,361, Harris et al U.S. Pat. No. 9,500,593), repairing composite structures (U.S. Pat. No. 9,810,596 Thomas and Dull), and in detecting leaks in the related molds (U.S. Pat. No. 8,438,909 Miller et al). Although it was used a number of times in the mold tool inspection application, these techniques have never achieved widespread adoption in manufacturing due to a series of limitations. One limitation is that there have been technical challenges to incorporating the materials into a satisfactory film, and the materials that have been successfully employed are very costly. A second limitation is that the equipment used in the detection process only works effectively in the dark, which is impractical for many components that are manufactured in an open factory setting. The camera system needs a dark environment to maximize the signal to noise ratio by eliminating light that is not being emitted by the sensor material. A third limitation is that complex photographic equipment, lighting, and image processing software must generally be used to effectively locate leaks according to previously employed methods and practices. This complexity and cost severely limits the practicality in use, particularly because specialized expertise may be required to effectively employ the system.

An additional reference includes U.S. Pat. No. 9,046,437 to Miller et al., entitled “Leak Detection in Vacuum Bags.” Miller discloses that air leaks in a seal beneath a vacuum bag are detected using a leak detection film inside the vacuum bag. The film includes a gas permeable binder and a gas sensitive material held in the binder. The gas sensitive material has at least one visual characteristic that changes in the presence of gas entering the vacuum bag through a leak in the seal. This is popular with resin-infusion type composite manufacturing and claimed a “double bag” method.

Still another reference is U.S. Pat. No. 8,707,766 to Harris et al., entitled, “Leak Detection Vacuum Bags.” Harris discloses a device that indicates the location of an air leak in a vacuum bag used to process composite parts. The device includes a layer of material on the inner face of the bag that changes in appearance due to an oxidation-reduction reaction in areas of the layer exposed to oxygen caused by a leak in the bag. Their disclosures apply to using colorimetric dye specifically, while the original indicator was based on light intensity variation (luminescent variation).

Although the potential for visual leak detection using oxygen-sensitive indicator materials has been demonstrated for vacuum bag processing, new apparatuses, systems and methods are required to provide practical techniques for leak detection in these and other vacuum based manufacturing techniques. Several new techniques will be described that may be more practical than previously known techniques in certain instances. These techniques may reduce equipment and material cost, reduce the time required to conduct the evaluation, reduce the required skill levels required by operators, and allow the evaluations to be conducted in a well-lit environment.

These new techniques may be applicable to both the primary manufacturing application and to other applications where pressure measurement is required.

### BRIEF SUMMARY OF THE PRESENT INVENTION

The present embodiment include new methods for bag leak detection, referred to hereafter as the “contrast method” and the “basic intensity method.” These methods have not been adapted from wind tunnel use, as the “lifetime” and “intensity” method have been. The new methods are using similar materials, but the method of determining the relative pressure is novel and non-obvious. These methods can be used in all potential pressure sensing applications, including, but not limited to use in manufacturing processes that use transparent vacuum bags, composite fabrication, composite tooling inspection, and composite repair.

According to one embodiment, a Luminescent Contrast Indicator is comprised of two adjacent components. The first component, a “Sensor Strip”, is comprised of an oxygen sensitive luminophore embedded in a substantially permeable carrier material. The Sensor Strip exhibits a visible effect from varying the oxygen concentration in the surrounding atmosphere. The second component, a “Reference Strip” is comprised of the same or similar type of luminophore embedded in a substantially impermeable carrier material. When excited by a UV or other excitation source both sides luminesce. The Reference Strip luminesces similarly in all environments because of the impermeable casing. The Sensor Strip luminesces in a manner very similarly to the Reference Strip when it is in a relatively low oxygen environment. It appears dimmer when more oxygen is present due to oxygen quenching. This method of pressure measurement using oxygen sensitive indicators is referred to as the “Contrast Method”. This method has certain advantages. The first of these advantages is that it can be readily used by almost any operator after very brief training. The only required equipment, in some instances is, a handheld UV light that costs about the same amount as a common flashlight. Because there is no image processing, it may be faster and less disruptive to use than the previously used methods for various pressure sensing applications. The variation in luminescent output that can be observed in the Sensor Strip is much more difficult to evaluate visually without the benefit of the adjacent Reference Strip.

This Contrast Method can be applied in other form factors as well. It may be applied as an alternating pattern of Sensor and Reference strips and disposed in a uniform manner across a broad area. This visual contrast is noticeable to the naked eye, and the operator may determine that the location with greatest contrast between the two types of strips has the highest oxygen pressure, and is potentially near a leak source. The detection can also be performed using a camera and image processing software if more precision is required.

A Reference Strip can also be used on the outside of the test area to approximately detect the pressure. For example, in the case of vacuum bag manufacturing processes, the Reference Strip can be movable article placed on or near the outer surface of the vacuum bag, while the Sensor is within the vacuum bag, but observable to the operator through the transparent vacuum bag. As in the previous case where the Reference Strip is within the test area, the reference strip is designed to appear identical to the sensor strip when they are both in the same oxygen concentration and illuminated similarly. For this outside-the-test-area configuration, the reference material is again contained in a known environment. In some cases this reference material will be held in an inert environment, with no available oxygen, which simulates a vacuum. This reference material is then placed adjacent to the sensor material, though separated by a transparent barrier of some type, for example an impermeable vacuum bag film. The reference material might also be contained in an air-tight container where the pressure can be controlled. The reference material can thus be adjusted to various pressures so as to determine more precisely the pressure in the test area. Alternatively, there can be a series of reference materials with various known oxygen concentrations, and the operator can examine them and compare them to the sensor material to discover the pressure in the test area. The process might be analogous to a painter trying to color match a sample.

To aid the operator in evaluating the oxygen sensitive indicator using the Contrast Method, a portable device may be employed that can be placed on the surface to be inspected. This device may be referred to as a Contrast Method Device or an optical pressure sensor, and is not required for employing the Contrast Method, but may be useful in certain circumstances. This device may be comprised of a hollow space which can be placed face-down against the surface to be inspected. It may contain an electromagnetic wave source such as an excitation light to excite the sensor materials. It creates a dark space by partially enclosing the test area, to mitigate the effects of any ambient light or reflections. This allows the operator to more easily employ the Contrast Method in a well-lit environment. The Contrast Method Device has a means of allowing the operator to view the sensor, either through a small opening or lens, or by means of a camera and screen. The device may, in some cases even contain a reference material, that is illuminated by the excitation light, and positioned so that the operator can look at the reference material and sensor material at the same time so as to evaluate the film. In other instances, the reference material may be separate from the Contrast Method Device.

These methods will be particularly useful in vacuum bag manufacturing processes because they may be used to assist in approximating the pressure under the vacuum bag film and in locating leaks. An oxygen sensor material, which is disposed in a manner substantially similar to the materials under the impermeable film, is contained within a transparent air-tight container. Within this container the partial pressure of oxygen is precisely known. In most circumstances the pressure used will most likely be near a vacuum. This reference material therefore will represent how the sensor will fluoresce under vacuum conditions. The reference material can be placed on the outside of the vacuum bag film so that it is adjacent to the sensor material and the area to be examined. Or it may be inside the vacuum bag adjacent to the sensor material and the area to be examined. It may be disposed locally or in a pattern across a broad area, for example there may be alternating lines of reference and sensor materials. Thus the reference material and the sensor material will be illuminated by the excitation light in approximately the same manner as the area under examination. If the pressure under the vacuum bag film is similar to the reference, then they will appear substantially identical. If the pressure under the vacuum bag film is different, then there will be a visible difference between the reference material and the sensor material disposed under the vacuum bag film.

There would be various configurations for the Contrast Method that may be useful in vacuum bagging. In one method, the reference material and the sensor material are disposed adjacent to each other in the form of an adhesive tape. This tape may then be disposed around the perimeter of the assembly and in areas thought to be vulnerable to leakage. One edge of the tape, the sensor material will react visibly when exposed to different pressures. On the other edge of the tape, the reference material will be contained in an impermeable material and luminesce similarly regardless of the pressure. In another method, the reference material may be held by the operator outside of the vacuum bag, and moved around as the bag is inspected for leaks.

In another embodiment, a new method is described that can be conducted with inexpensive and rudimentary equipment in a fully lit environment. The Discrete Luminescence Method for evaluating oxygen sensitive luminophores relies on repeatable conditions, rather than a reference image and complex image processing. This method uses a handheld device which can evaluate the oxygen pressure only in a single discrete location at any one time, rather than across a broad area, as pre-existing imaging based methodologies have done. The device contains a photosensor and an electromagnetic wave source such as an excitation light selected for its compatibility with the selected luminophore. The photosensor may have a filter on it so that only light of the approximate wavelength that is emitted from the oxygen sensitive luminophore material will be received by the photosensor. The photosensor may be a photo-voltaic, photo-emissive, photo-conductive, photo-junction, or other device that may be used to measure the intensity of an electromagnetic wave. The excitation source, may be limited by a filter, so that only certain wavelengths, such as UV, are allowed to pass. The device is placed face down on the test area, and over the sensor material. By positioning it in this way, a dark space is created that substantially eliminates ambient light. As the device is moved to evaluate various areas, the intensity of the excitation light, the position of the light intensity sensor, the ambient darkness, and other conditions, are all held constant. This eliminates the need for reference images and complex image processing, especially if the goal is just to find areas with higher or lower relative pressures. In the case of vacuum bag evaluation, the device is placed face down on the vacuum bag adjacent to the oxygen sensitive sensor material, which is contained within the impermeable vacuum bag film. The excitation light contained within the device then illuminates the oxygen sensitive sensor material. The light intensity sensor then measures the intensity of light being emitted by the oxygen sensitive sensor indicator material. The oxygen pressure around the oxygen sensitive sensor material can then be ascertained by the output of the light intensity sensor via a controller including a microcontroller. In the case of a leak check, this device can be moved around to evaluate different locations and measure their relative pressures. The areas with higher pressure may be inferred to be near the source of a leak. If the sensor is to be used to measure a pressure with more accuracy, it may be necessary to develop a calibration curve for the particular configuration in use.

The Contrast Method and the Discrete Luminescence Method can also be used as a rapid and more approximate alternative to the Intensity Method or Lifetime Method. These methods can be used either as a replacement for, or a supplement to the previously known methods. For example, the Contrast Method might be used for a preliminary check in full-light conditions as a vacuum bag is being applied. Then a final check might be conducted in full darkness with a more precise Lifetime Method using a computer controlled camera, lighting, and image processing software. The same sensor materials can be used for the various methods of evaluation.

There is also a need for reducing the recurring material cost in vacuum bagging applications. The oxygen sensitive indicators with the best performance tend to be extremely expensive. Within the field of vacuum bag manufacturing, certain methods of use for these indicators have previously been described (for example, in Miller and Benne U.S. Pat. No. 7,849,729B2). In this, and subsequent disclosures, the entirety of the component being manufactured is substantially covered with a pressure-sensing film. Although covering the entirety of the part was quite expensive, it was not then a major concern, because the camera and software system was also extremely expensive, so reducing cost in the area of sensor material still would not make the overall process substantially inexpensive. Because the Contrast Method and Discrete Luminescence Method eliminate the need for expensive ancillary equipment, these new methods may make this method of pressure sensing and leak detection practical for a broader array of applications, provided that the material costs are reasonable. For example these new methods may be practical to use for lower value manufacturing applications that use vacuum bags, or for locating a leak in a weld or other surface. Two main avenues for cost reduction will be described, which generally rely on limiting the area to be covered with the oxygen sensitive material, and by increasing the re-usability by embedding the oxygen sensitive material in a durable carrier.

According to one embodiment, an oxygen-sensitive indicator material is incorporated into a polymeric substrate in the form of a solid disk, strip, or other shape. The polymer is permeable to oxygen. In one instance, the disks were round and flat, approximately 0.05 inches thick and 2 inches in diameter. The polymeric substrate may alternatively be formed into a thin strip about 1 inch wide, although the precise shape is not particularly important. Silicone materials were initially used due to their relatively high permeability and high temperature capability. These oxygen-sensitive materials are generally procured as a powder. In the case of thermoplastic polymer substrates, they can generally be incorporated into the polymer substrate by compounding them into pellets in the same manner that dyes or other materials may be added. In the case of thermosetting polymer materials (liquid materials that solidify through a chemical reaction), the oxygen sensor can be mixed into the liquid ingredients by stirring or other mechanical means. This oxygen-sensitive substrate can now be employed for pressure sensing techniques which are described subsequently. By incorporating the sensor materials into a durable polymer, they can be reused many times. Unlike techniques that require manufacturing a thin transparent film which incorporate the oxygen sensor, this method is low cost and requires only a very minimal modification to existing manufacturing processes, and potentially does not require requalification of the manufacturing process or materials. Large composite parts, which are manufactured using vacuum bags, can be hundreds of square meters in surface area, as in the case of boat hulls, aircraft wings, and wind turbine blades. In such examples, even a slight increase in the cost of consumable materials used in the manufacturing process may be prohibitive to adoption. By locating the sensor materials at discreet intermittent locations, the cost may be significantly reduced compared to covering an entire surface. This configuration can be used with the various evaluation methods, including the Contrast Method, the Discrete Luminescence Method, the Intensity Method, or the Lifetime Method. In the case of the Contrast Method, the disk or strip may be fabricated to manufacture a Luminescent Contrast Indicator with the oxygen sensitive luminophore encased, in one area, by a permeable material, and in another adjacent area, by an impermeable material. In this way it provides a reference material and a sensor material.

According to another embodiment, the oxygen-sensitive material can be incorporated into a polymer film, and then into an adhesive tape. Relatively permeable thermoplastics can be used for this application, such as PE, PP, FEP, PTFE, PMP, ETFE or other polymers. The thermoplastic will generally be extruded as a thin-film. Coatings with the luminophore incorporated thermosetting materials or adhesive layers such as silicones and permeable acrylics can also be used. Depending on the use condition, it may be important that the polymer has a high temperature capability. It may be possible to apply the dye to a metal surface using an anodizing process as well, although this has not been demonstrated for this application. This encapsulated luminophore may then be disposed upon the mold surface around the perimeter of the seal or in other areas thought to be vulnerable to leakage. This configuration has many of the same advantages as the solid pressure sensing disk or strip. It may be semi-permanently disposed onto the mold surface and reused many times, and it is more practical and affordable than covering the entire part surface with a detection film. Even if used only once, the adhesive allow a much smaller area of material to be precisely positioned, and held so that it is not disturbed during the application of the vacuum bag and other materials. This adhesive tape may be embossed with a surface texture to promote or limit air flow over the surface. This configuration can be used with the various evaluation methods, including the Contrast Method, the Discrete Luminescence Method, the Intensity Method, or the Lifetime Method. In the case of the Contrast Method, the tape may be fabricated in such a way so that the oxygen sensitive material is encased, in one area, by a permeable material, and in another adjacent area, by an impermeable material. In this way it provides a reference material and an adjacent sensor material.

These various embodiments may be employed individually or all together, and provide a new method for locating leaks and measuring oxygen pressure through an impermeable film. Unlike prior methods to use oxygen-sensitive visual indicators to measure pressure and detect leaks in vacuum bag membrane, the Contrast Method and the Discrete Luminescence Method are less expensive, easier to use, and in some cases do not require a dark environment to use. Although initially conceived to be used in a manufacturing process to verify vacuum integrity, they may also be used in a secondary application of evaluating a surface for cracks or leaks. In this context the system is not used during a manufacturing process. The leak detection film method has been used for evaluating the vacuum integrity of mold tools used for composite fabrication, see for example U.S. Pat. No. 8,438,909 Miller et al. These new methods can also be used for that purpose, or for evaluating vacuum integrity in composite tools or for other applications, such as determining if a package has remained sealed, or determining if a crack or potential air-path in a surface extends all the way through.

### BRIEF DESCRIPTION OF THE DRAWINGS

FIG. 1 is a perspective view illustrating how a sensor strip can be disposed around the perimeter of a composite preform under an impermeable transparent vacuum bag film.

FIG. 2 is a perspective view illustrating how sensor patches or disks can be disposed intermittently around the perimeter of a composite part under an impermeable transparent vacuum bag film.

FIG. 3 shows a cross section view of a typical fiber reinforced polymer preform being manufactured with the aid of a vacuum bag and an oxygen-sensitive material.

FIG. 4 is a perspective view illustration illustrating how a sensor strip can be disposed around the perimeter of a composite preform under an impermeable transparent vacuum bag film. An excitation light, camera, and reference standard are shown. The reference standard contains the sensor material exposed to a known amount of oxygen, which can be compared to the sensor material under the vacuum bag film. The reference standard may be placed immediately adjacent to the sensor material under the vacuum bag film, to allow the operator to examine the sensor material using the Contrast Method.

FIG. 5 shows a cross section view of a typical fiber-reinforced polymer preform being manufactured with the aid of a vacuum bag and an oxygen-sensitive material. The sensor material is contained within a permeable material, and is disposed next to other sensor material contained within an impermeable material, known as a reference. This allows the operator to evaluate the sensor material using the Contrast Method.

FIG. 6 shows a cross section view similar to FIG. 5, but with the addition of a Contrast Method Device, which may be used to evaluate the sensor and reference using the Contrast Method.

FIG. 7 shows a cross section view similar to FIG. 5, but with the addition of a Discrete Luminescence Method Device, which may be used to evaluate the sensor and reference using the Discrete Luminescence Method.

FIG. 8 shows a cross sectional view substantially impermeable polymer film or vacuum bag film used in combination with sensor material contained within a permeable solid.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this Specification are hereby incorporated by reference in their entireties. References cited in an Information Disclosure Statement should not be construed as an admission that the cited reference comes from an area that is analogous or directly applicable to the invention, but rather that the reference is being cited out of an abundance of caution.

Turning to the Figures, FIG. 1 is a vacuum bagged composite part is shown during fabrication. An assembly or “preform” of composite fibers (4) is disposed upon a rigid mold tool (1). A resin is embedded in the fibers either before or after their disposition, using one of various methods. Typically, ancillary materials, such as breather or release film, are also disposed over the preform (not visible here). Around the perimeter of the preform, an oxygen-sensitive tape or strip (3) is disposed. An impermeable transparent polymer film (2), known as a vacuum bag film, is disposed over the preform and oxygen-sensitive strip, and sealed to the rigid mold tool with sealant tape. The air contained between the vacuum bag film and the mold tool is then evacuated through a vacuum port (not shown), allowing the surrounding atmospheric pressure to compress the composite preform. The oxygen-sensitive tape or strip can then be evaluated to determine the pressure under the vacuum bag and to aid in determining if and where any leaks may exist.

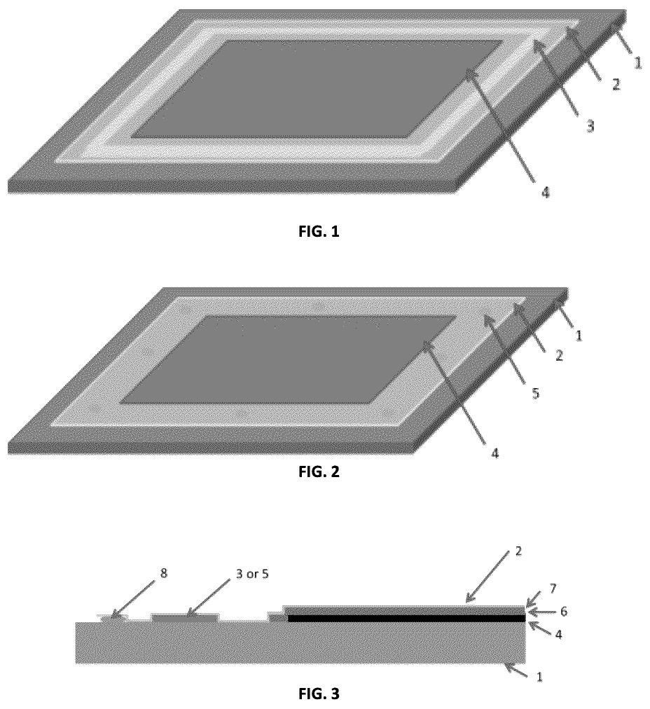

FIG. 2 shows an alternative embodiment, where small reusable oxygen-sensitive disks can be used at discreet locations under the vacuum bag film. This configuration may be more practical on very large parts, or in situation where it may not be convenient to use continuous strips disposed around the perimeter. Using disks may have an ancillary benefit in that they are somewhat isolated from each other by the vacuum bag film partially isolating them from each other. This isolation may tend to increase the pressure differences from one disk to the next, which may help to make a leak source location more noticeable compared to using a continuous strip around the perimeter. The oxygen-sensitive disk can then be evaluated to determine the pressure under the vacuum bag at various discrete locations and to aid in determining if and where any leaks may exist.

In FIG. 3, the same or similar configuration to FIGS. 1 and 2 is shown in partial cross section view. A vacuum bagged composite part is shown during fabrication. An assembly, or “preform”, of composite fibers (4) is disposed upon a rigid mold tool (1). Release film (6) is disposed over the composite preform. This release film functions to allow separation of the finished composite structure from surrounding breather, vacuum bag, and from other materials used during the manufacturing process. A breather material (7) is disposed over the release material. The breather is intended to allow thorough and efficient evacuation of gas from the assembly. Around the perimeter of the preform, an oxygen-sensitive tape or strip (3) is disposed. An impermeable transparent polymer film (2), known as a vacuum bag film, is disposed over the preform and oxygen-sensitive strip and sealed to the rigid mold tool with sealant tape (8). The air contained between the vacuum bag film and the mold tool is then evacuated through a vacuum port (not shown), allowing the surrounding atmospheric pressure to compress the composite preform. The oxygen-sensitive tape or strip can then be evaluated to determine the pressure under the vacuum bag and to aid in determining if and where any leaks may exist. By using a tape or strip, rather than a leak detection film disposed across the entire part, the materials may be much lower cost and may be reusable.

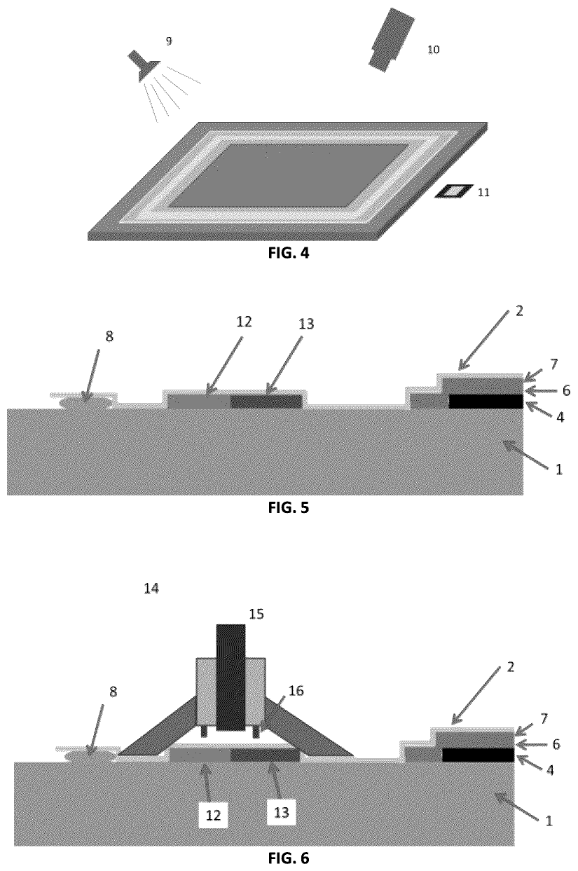

Whether the operator is using the sensor strip, sensor disk, or a film disposed substantially over the entire assembly, as has been previously disclosed in U.S. Pat. No. 7,849,729, there are several ways to evaluate the sensor. A method of using an excitation light (9), a camera (10), and image processing software, which has previously been used in combination with a pressure sensitive film disposed over the part, has been previously disclosed. The variations in the light emissions from the sensor materials are evaluated by the camera and software to locate potential leak locations. In practice, this type of testing must be done in a dark environment to maximize the visibility of the effects being measured. The naked eye can also be used, but it has generally been too insensitive to effectively determine pressure gradients. Because the excitation light may be illuminating one area with greater intensity than another, the variations in appearance may either be indicative of differences in oxygen concentration (indicating a leak or pressure difference) or of greater or lesser intensity in the excitation of the sensor materials. In FIG. 4, a portable reference material (11) is used. This reference material is comprised of the sensor material held at a certain known pressure. For instance, it might be embedded in impermeable materials or contained within an atmosphere with a known oxygen concentration. This reference material can be moved around the part and used to present a visual contrast between the reference material and the sensor material contained between the impermeable transparent vacuum bag film and the rigid tool. This manner of evaluation is known as the Contrast Method. Because the reference material is adjacent to the sensor material, the degree to which they both are illuminated by the excitation light (9), will be substantially identical. It may be helpful to dispose a piece of transparent vacuum bag film over the reference material to duplicate the effect it may have on light transmission to and from the sensor material that is contained within the vacuum bag. Therefore, the differences in visual appearance between the sensor material and the reference material can be inferred to be due to differences in oxygen concentration, and not due to differences in excitation. This allows a visual evaluation to be more effectively conducted without complex camera and image processing software. The evaluation may be conducted in combination with the camera equipment (10), or without this equipment.

FIG. 5 is similar to FIG. 3, but instead shows one embodiment where a reference material is disposed adjacent to the sensor material as has been described previously as a Luminescent Contrast Indicator. This reference material (13) may be positioned separately, it may be attached to the sensor material (12), or it may be contained within a material disposed in a striped or other pattern. The reference material may be incorporated into a strip or patch, or it may be disposed in a broad pattern across a film that substantially covers the assembly. The vacuum bag film itself can have the reference material and sensor material embedded on the inward facing surface. As with the outside portable reference material shown in FIG. 4, the under-the-bag reference material is designed to present a visual contrast and thus enable to interrogate the sensor material using the Contrast Method. The reference material may be comprised of sensor material embedded in or encapsulated within impermeable transparent material. This reference material will vary in visual appearance based on the degree of excitation, but not based on changes in oxygen pressure. Because the reference material is adjacent to the sensor material the degree to which they both are illuminated by the excitation light (9), will be substantially identical. Therefore, the differences in visual appearance between the sensor material and the reference material can be inferred to be due to differences in oxygen concentration, and not due to differences in excitation. This allows for more effective visual observation of differences in pressure.

In FIG. 6, a portable Contrast Method Device (14) is used to evaluated the sensor material (12), and may be more accurate than evaluating the visual contrast by the naked eye. The sensor material may or may not be disposed adjacent to a reference material (13). The device (14) functions by blocking out ambient light in the area to be evaluated. The sensor material is then excited with an illumination source (16). This illumination source may, for example, be a UV or blue LED light, which may be powered by batteries or another power source. The sensor material can then be compared to the reference material through an eyepiece (15). The eyepiece may optionally use magnification or a filter to block certain light wavelengths. Instead of an eyepiece, a camera or photosensor may be used, and the resulting image can be displayed on an external screen, or transmitted to another screen. The image or photosensor data can be evaluated digitally if greater precision is required, in which case no eyepiece may be required. The great advantage of this method is that it can be done in a well-lit room or anywhere else, unlike prior evaluation techniques which required darkness.

In an alternative configuration to the one shown in FIG. 6, the Contrast Method Device can contain a reference material, which is the same in function as is described for FIG. 4. This reference material can be affixed to the portable device and positioned in such a way that when the user looks through the eyepiece, the user can see both the reference material, which is outside the impermeable vacuum bag film, and the sensor material beneath the vacuum bag film. The sensor material can then be compared to the reference material, and some inference may be made about the pressure under the vacuum bag. This portable illumination and optical viewing device may be used in combination with a sensor material disposed in a strip, tape, or disk, as have been disclosed here, or they may be used in combination with a leak detection film, as previously described.

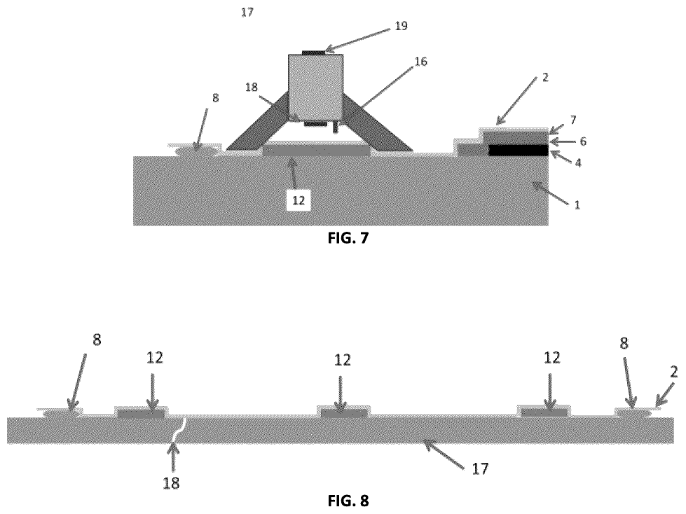

In FIG. 7 a Discrete Luminescence Method Device (17) is used to assess the oxygen pressure under the vacuum bag film. The device (17) functions by blocking out ambient light in the area to be evaluated. The sensor material is then excited with an illumination source (16). A photosensor (18), which may be comprised of any type of sensor which can be used to measure the intensity of the light emitted from the sensor material. The output from this sensor material is then displayed on a screen (19) on the top surface of the device. Alternatively, it may be displayed to the user in some other way. This method may be accurate enough to measure the pressure under the bag. The device may require calibration by viewing the sensor material at known pressures, but thereafter it may be possible to measure the pressure under the bag using this system. This portable illumination and digital photosensor device may be used in combination with a sensor material disposed in a strip, tape, or disk, as have been disclosed here, or they may be used in combination with a leak detection film, as previously described.

In FIG. 8 a transparent substantially impermeable polymer film or vacuum bag film (2) is used in combination with sensor material (12) contained within a permeable solid, such as silicone rubber to detect and locate a crack or undesirable air-path (18) through a solid surface (17). The sensor material may alternatively be contained within an adhesive tape. The vacuum bag film is sealed (8) to the solid surface (17) for the purpose of inspecting that surface for cracks, holes, or other defects that may allow a gas or liquid leak. This may be beneficial for applications where it is difficult to otherwise inspect for undesirable leaks. Examples may include mold tools for composite fabrication, pressure vessels, pipes or connectors used to transmit a gas or liquid, etc. Unlike other evaluation methods, as long as there is oxygen on the side opposite the vacuum bag, no back-side access is required for testing. The various evaluation methods and configurations described previously for manufacturing applications can similarly be used for this inspection application. This application has been used with the Lifetime Method and the Intensity Method, in combination with a film disposed substantially over the entire test area, as described previously. It may be beneficial to conduct this manner of testing using the Contrast Method and the Discrete Luminescence Method. It may be beneficial to have the sensor material embedded within an adhesive tape or reusable polymeric disk or strip.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.
Clause 1. An apparatus or system comprising any feature described, either individually or in combination with any feature, in any combination.
Clause 2. A process or method of using the product, comprising any steps described, either individually or in combination with any steps.
Clause 3. A process of manufacturing a product, the product comprising any feature described, either individually or in combination with any feature, in any combination, the process comprising any steps described, either individually or in combination with any steps.
Clause 4. An apparatus for sensing local oxygen pressure, comprising: a) a first luminophoric material sensitive to oxygen, encased within a permeable material; and b) a second luminophoric material, of the same or similar type as the first luminophoric material, encased within an impermeable material, wherein a contrast in the electromagnetic waves emitted from each of the first and second luminophoric materials provides an indication of the local oxygen pressure.
Clause 5. The apparatus of clause 4, further comprising: (a) a photosensor configured to detect the luminescent output from the first and second luminophoric materials; and (b) an electromagnetic wave source configured to excite the first and second luminophoric materials, wherein the local oxygen pressure is deduced based on the intensity of the luminescent output.
Clause 6. A system for detecting local oxygen pressure, comprising: a) a first luminophoric material sensitive to oxygen, encased within a permeable material; b) a second luminophoric material, of the same or similar type as the first luminophoric material, encased within an impermeable material; and c) means for contrasting the electromagnetic waves emitted from the first and second luminophoric materials to provide an indication of the local oxygen pressure.
Clause 7. The system of clause 6, further comprising: a) a photosensor for detecting the luminescent output from the luminophoric materials; and b) an electromagnetic wave source for exciting the luminophoric materials.
Clause 8. A method for detecting local oxygen pressure, comprising the steps of: a) encasing a first oxygen-sensitive luminophoric material in a permeable material; b) encasing a second oxygen-sensitive luminophoric material in an impermeable material; c) exciting both the first and second luminophoric materials; d) detecting electromagnetic waves emitted from each of the luminophoric materials; and e) contrasting the detected electromagnetic waves to provide an indication of the local oxygen pressure.
Clause 9. The method of clause 8, further comprising the steps of: f) using a photosensor to detect the luminescent output from the luminophoric materials; and g) utilizing an electromagnetic wave source to excite the luminophoric materials.

What is claimed is:

1. An apparatus or a system comprising any feature described, either individually or in combination with any feature, in any combination.

2. A process or method of using the product, comprising any steps described, either individually or in combination with any steps.

3. A process of manufacturing a product, the product comprising any feature described, either individually or in combination with any feature, in any combination, the process comprising any steps described, either individually or in combination with any steps.
